(19) United States
(12) Patent Application Publication
(10) Pub. No.: US 2018/0298771 A1
(43) Pub. Date: Oct. 18, 2018

(54) POLYMERIC ACTUATION PIVOT SHAFT SEAL

(71) Applicant: BorgWarner Inc., Auburn Hills, MI (US)

(72) Inventor: George Edward Heddy III, HENDERSONVILLE, NC (US)

(21) Appl. No.: 15/485,521

(22) Filed: Apr. 12, 2017

(51) Int. Cl. F01D 11/00; F02B 37/24; F02B 33/40

(52) U.S. Cl. CPC F01D 11/003; F01D 5/04; F02B 33/40; F02B 37/24

(57) ABSTRACT

A number of variations may include a pivot shaft assembly for a variable turbine geometry turbocharger comprising: a pivot shaft and a polymeric seal surrounding a portion of the pivot shaft, wherein the polymeric seal comprises a first layer and a second layer surrounding at least a portion of the first layer, and wherein the first layer comprises a perfluoroelastomer and the second layer comprises a polytetrafluoroethylene.

### TECHNICAL FIELD

The field to which the disclosure generally relates to includes variable turbine geometry (VTG) turbochargers.

### BACKGROUND

A turbocharger may include VTG using vanes in front of a turbine inlet.

### SUMMARY OF ILLUSTRATIVE VARIATIONS

A number of variations may include a pivot shaft assembly for a variable turbine geometry (VTG) turbocharger comprising: a pivot shaft and a polymeric seal surrounding a portion of the pivot shaft, wherein the polymeric seal comprises a first layer and a second layer surrounding at least a portion of the first layer, and wherein the first layer comprises a perfluoroelastomer and the second layer comprises a polytetrafluoroethylene.

A number of variations may include a variable turbine geometry (VTG) turbocharger comprising: a turbine housing defining a turbine housing interior; a turbine wheel disposed within the turbine housing interior; a turbocharger shaft coupled to and rotatable by the turbine wheel, with the turbocharger shaft extending along a longitudinal axis that extends longitudinally through the turbine housing interior; a compressor housing defining a compressor housing interior; a compressor wheel disposed within the compressor housing interior and coupled to the turbocharger shaft, with the compressor wheel being rotatable by the turbocharger shaft; a bearing housing extending along the longitudinal axis between the turbine housing and the compressor housing, with the bearing housing defining a first bore extending along the longitudinal axis for receiving the turbocharger shaft and a second bore spaced from the first bore and extending along the longitudinal axis; and a variable turbine geometry assembly comprising, a vane ring disposed within the turbine housing interior and extending along the longitudinal axis, a plurality of vanes coupled to and movable with respect to the vane ring, an adjustment ring disposed between the vane ring and the bearing housing and extending along the longitudinal axis, with the adjustment ring coupled to the plurality of vanes for moving the plurality of vanes relative to the vane ring, a pivot shaft coupled to the adjustment ring and extending along the longitudinal axis, with the pivot shaft disposed within the second bore of the bearing housing, and with the pivot shaft configured to be actuated by the actuator for moving the adjustment ring with respect to the vane ring to move the plurality of vanes with respect to the vane ring, and a polymeric seal disposed within the second bore of the bearing housing for minimizing exhaust gas leakage from the turbine housing to an environment surrounding the bearing housing, with the polymeric seal comprising, a first layer disposed about the pivot shaft comprising a perfluoroelastomer, and a second layer adjacent the first layer and disposed about the pivot shaft, with the second layer comprising a polytetrafluoroethylene.

A number of variations may include a method of sealing a pivot shaft within a bore of a bearing housing of a turbocharger comprising: providing a polymeric seal within the bore of the bearing housing and around the pivot shaft to minimize exhaust gas leakage from the turbine housing to an environment surrounding the bearing housing, wherein the polymeric seal comprises a first layer comprising a perfluoroelastomer and a second layer comprising a polytetrafluoroethylene.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a section view of a VTG turbocharger according to a number of variations.

FIG. 2 illustrates a close-up section view of a VTG turbocharger according to a number of variations.

FIG. 3 illustrates a close-up section view of an actuation pivot shaft assembly according to a number of variations.

FIG. 4 illustrates a close-up section view of an actuation pivot shaft assembly according to a number of variations.

FIG. 5 illustrates a plan view of an actuation pivot shaft seal according to a number of variations.

FIG. 6 illustrates a section view taken along A-A of FIG. 5 according to a number of variations.

FIG. 7 illustrates a section view of an actuation pivot shaft with an actuation pivot shaft seal according to a number of variations.

### DETAILED DESCRIPTION OF ILLUSTRATIVE VARIATIONS

The following description of the variations is merely illustrative in nature and is in no way intended to limit the scope of the invention, its application, or uses.

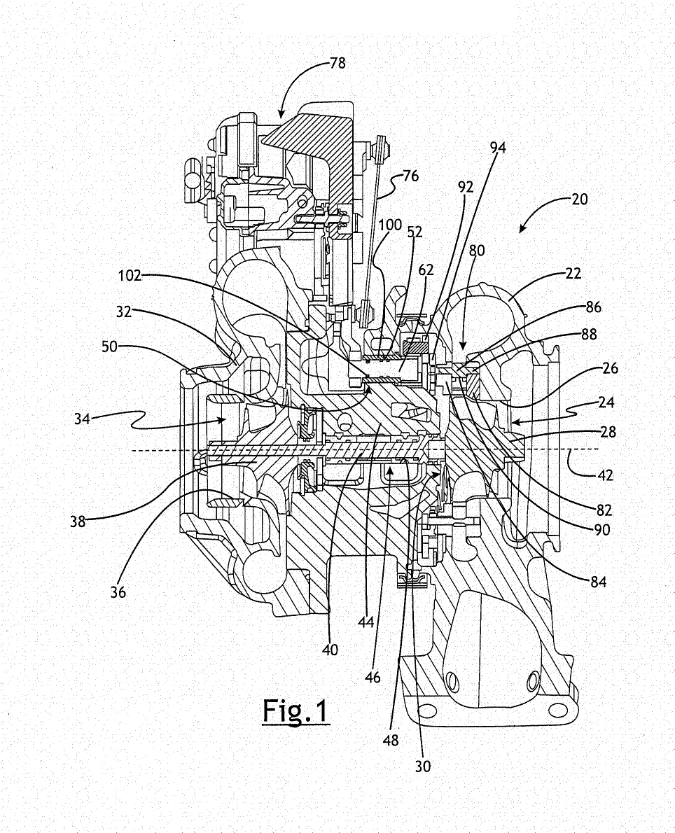

Referring to FIG. 1, in a number of variations, a VTG turbocharger 20 may be used to expand the usable flow rate range of an engine while at the same time maintaining a high level of efficiency. In a number of variations, the VTG turbocharger 20 may include a turbine housing 22 which may include an internal cavity 24 defined by a first inner surface 26 of the turbine housing 22 and a compressor housing 32 which may include an internal cavity 34 defined by an inner surface 36 of the compressor housing 32. In a number of variations, a turbine wheel 28 may be disposed within the internal cavity 24 of the turbine housing 22 and may be operatively attached to a compressor wheel 38, which may be disposed within the internal cavity 34 of the compressor housing 32, via a turbocharger shaft 40. The turbocharger shaft 40 may rotate about an axis of rotation 42 and may extend longitudinally through the VTG turbocharger 20. The term “radial” used hereafter refers to a direction which extends from or is substantially perpendicular to the axis of rotation 42 of the turbocharger shaft 40 and the term “axial” as used hereafter refers to a direction along or substantially parallel to the axis of rotation 42 of the turbocharger shaft 40.

In a number of variations, the turbine wheel 28 may be driven by exhaust gas fluid-flow which may cause the turbine wheel 28 to rotate about the axis of rotation 42 of the turbocharger shaft 40 which may cause the turbocharger shaft 40 to rotate about the axis of rotation 42 which may then drive the compressor wheel 38. The compressor wheel 38 may then pressurize air which may enter the internal combustion engine.

In a number of variations, a bearing housing 44 may be disposed between the turbine housing 22 and the compressor housing 32. In a number of variations, the bearing housing 44 may include a first bore 46 which may extend axially through the bearing housing 44 defined by a first inner surface 48 of the bearing housing 44 constructed and arranged to accommodate the turbocharger shaft 40. In a number of variations, the bearing housing 44 may also include a second bore 50 offset from the first bore 46 which may extend axially through the bearing housing 44 defined by a second inner surface 52 of the bearing housing 44 constructed and arranged to accommodate an actuation pivot shaft 62 as will be discussed hereafter.

In a number of variations, a vane pack assembly 80 may be positioned within the turbine housing 22 adjacent an inlet 30 of the turbine housing 22 and the bearing housing 44 and may be constructed and arranged to regulate the turbine output by changing the inflow area and the inflow speed at the turbine inlet 30.

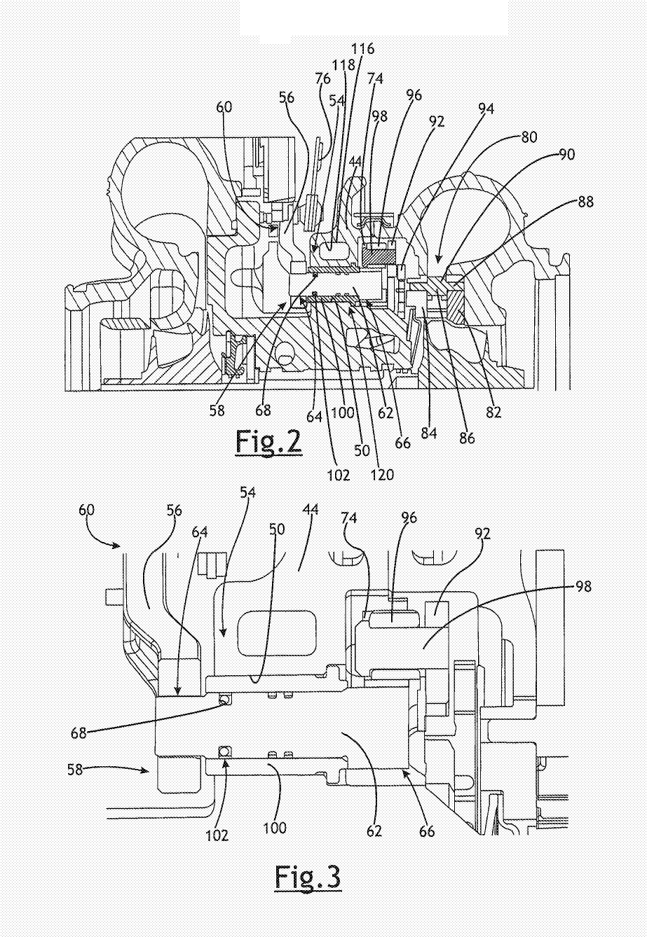

Referring to FIGS. 1 and 2, in a number of variations, a vane pack assembly 80 may comprise a lower vane ring 82, an upper vane ring 84, and a plurality of vane components 86 circumferentially spaced between the lower vane ring 82 and the upper vane ring 84. The vane components 86 may each include a vane shaft 88 and a vane 90 which may rotate within the lower vane ring 82 and the upper vane ring 84. In a number of variations, an adjustment ring 92 may be located adjacent the upper vane ring 84 and the bearing housing 44 and may be constructed and arranged to rotate around the upper vane ring 84 about the axis of rotation 42. In a number of variations, a plurality of vane levers 94 may be attached to each of the plurality of vane components 86 and the adjustment ring 92. In a number of variations, when the adjustment ring 92 may be rotated, the position of the vane levers 94 may rotate which may cause the vane shafts 88 to rotate causing the position of the vanes 90 to rotate.

Referring to FIGS. 2-3, in a number of variations, a pivot arm assembly 54 may be constructed and arranged to rotate the adjustment ring 92. In a number of variations, the pivot arm assembly 54 may include a pivot arm 56 having a first end 58 and a second end 60. In a number of variations, the first end 58 of the pivot arm 56 may be attached to a first end 64 of a pivot shaft 62. In a number of variations, the second end 66 of the pivot shaft 62 may include or may be attached to a pivot fork 74 which may be operatively attached to a turning block 96. In a number of variations, the turning block 96 may be attached to the adjustment ring 92 via a pin 98 which may extend perpendicularly from the adjustment ring 92. In a number of variations, a second end 60 of the pivot arm 56 may be attached to a link arm 76, a variation of which is illustrated in FIGS. 1 and 2. In a number of variations, the link arm 76 may be operably attached to an actuator 78, a variation of which is illustrated in FIG. 1, which may selectively move the link arm 76 linearly between a fore and aft position and to positions therebetween. In a number of variations, when the link arm 76 may be moved between the fore and aft positions, it may cause the pivot arm 56 to rotate which may act on the turning block 96 causing the adjustment ring 92 to rotate. The rotation of the adjustment ring 92 may cause the vanes 90 to rotate which may vary the flow of fluid exiting the turbine housing 22.

Referring to FIGS. 1-4 and 7, in a number of variations, the pivot shaft 62 may be positioned within the second bore 50 in the bearing housing 44. In a number of variations, a bushing 100 may, but is not required to, surround at least a portion of the pivot shaft 62, variations of which are illustrated in FIGS. 1-4. In a number of variations, a polymeric seal 102 comprising high temperature elastomers including, but not limited to, perfluroelastomer (FFKM) and polytetrafluoroethylene (PTFE), may surround at least a portion of the pivot shaft 62 and may be positioned between the pivot shaft 62 and the second bore 50 of the bearing housing 44 and/or the bushing 100 (if present), and may be constructed and arranged to reduce or minimize soot and/or exhaust gas leakage from the turbine housing 22 to an environment outside of the turbine housing 22. In a number of variations, the polymeric seal 102 may extend within a groove 68 which may extend radially around and within a portion of the pivot shaft 62.

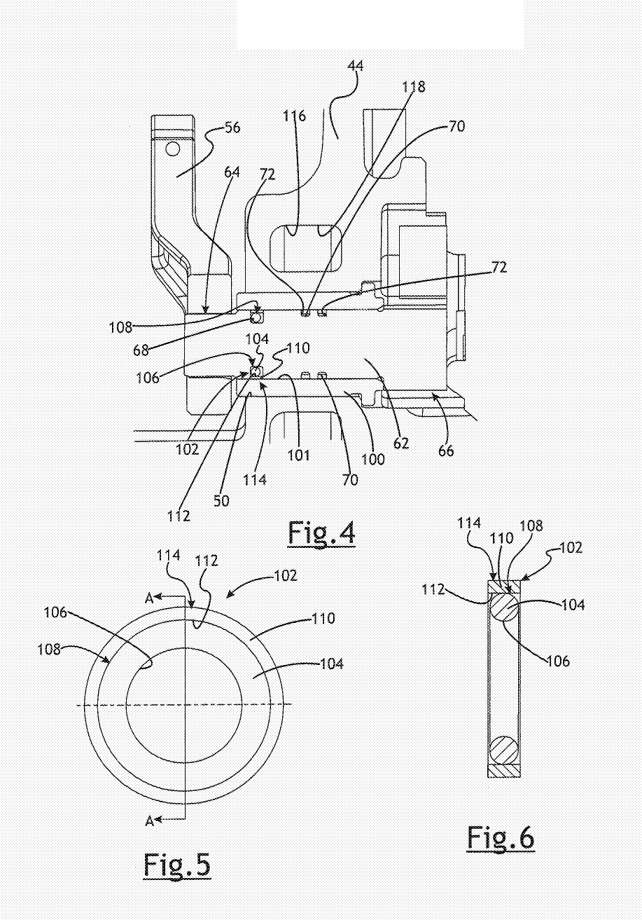

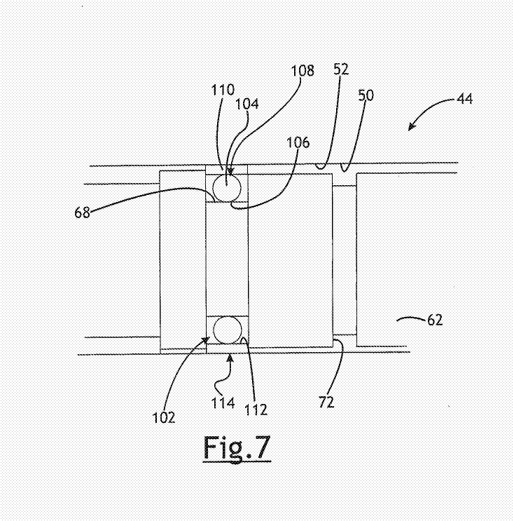

Referring to FIGS. 5-7, in a number of variations, the polymeric seal 102 may comprise a first layer 104 and a second layer 110. In a number of variations, the first layer 104 may comprise a FFKM and may include an inner surface 106 and an outer surface 108. In a number of variations, at least a portion of the inner surface 106 of the first layer 104 may be in contact with the outer diameter of the pivot shaft 62, a variation of which is illustrated in FIG. 7. In a number of variations, the second layer 110 may comprise a PTFE including, but not limited to, a hi-temp or modified PTFE. In a number of variations, the second layer 110 may include an inner surface 112 and an outer surface 114. In a number of variations, at least a portion of the inner surface 112 of the second layer 110 may be in contact with the outer surface 108 of the first layer 104, and the outer surface 114 of the second layer 110 may be in contact with the second inner surface 52 of the bearing housing 44 defining the second bore 50, a variation of which is illustrated in FIG. 7, and/or the inner surface 101 of the bushing 100, a variation of which is illustrated in FIG. 4. In a number of variations, the second layer 110 may be constructed and arranged to slide against a metal surface including, but not limited to, the bearing housing 44 and/or the bushing 100, while surrounding at least a portion of the first layer 104 to protect the first layer 104, which may extend the life of the polymeric seal 102. In a number of variations, the polymeric seal 102 may be able to operate at elevated temperatures as high as 327° C./621° F. This may allow for improved sealing effectiveness of the actuation pivot shaft over sealing utilizing only metal seals.

It is noted that the figures illustrate the first layer 104 of the polymeric seal 102 as being in the form of an O-ring and the second layer 110 of the polymeric seal 102 being in the form of an end cap for illustrative purposes only, and any number of configurations of polymeric seal designs comprising the first layer 104 and the second layer 110 may be used without departing from the spirit and scope of this invention.

Referring to FIG. 4, in a number of variations, one or more piston ring seals 70 may be positioned adjacent to the polymeric seal 102. In a number of variations, the one or more piston ring seals 70 may extend within one or more piston ring grooves 72 which may extend radially within the actuation pivot shaft 62. In a number of variations, the use of the one or more piston ring seals 70 may provide additional sealing improvements.

Referring to FIGS. 2 and 4, in a number of variations, the bearing housing 44 and/or the pivot arm bushing 100 may be cooled to maintain the polymeric seal 102 within its temperature capability range. The bearing housing 44 and/or the bushing 100 may be cooled in any number of ways including, but not limited to, water cooling. In a number of variations, the bearing housing 44 may include a water jacket 116, defined by an inner surface 118 of the bearing housing 44 which may extend radially around the second bore 52 and the bushing 100 (if present). In a number of variations, the bearing housing 44 may also include a dam 120, a variation of which is illustrated in FIG. 2, which may be used to force the flow of water into one side of the bushing 100 and then out of the bushing 100, which may prevent water from becoming stagnate around the bushing 100.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a pivot shaft assembly for a variable turbine geometry (VTG) turbocharger comprising: a pivot shaft and a polymeric seal surrounding a portion of the pivot shaft, wherein the polymeric seal comprises a first layer and a second layer surrounding at least a portion of the first layer, and wherein the first layer comprises a perfluoroelastomer and the second layer comprises a polytetrafluoroethylene.

Variation 2 may include a pivot shaft assembly as set forth in Variation 1 wherein the pivot shaft comprises a radial groove, and wherein at least a portion of the polymeric seal is disposed within the radial groove.

Variation 3 may include a pivot shaft assembly as set forth in any of Variations 1-2 further comprising a bushing, and wherein the bushing surrounds the polymeric seal.

Variation 4 may include a pivot shaft assembly as set forth in any of Variations 1-3 wherein the first layer includes a first inner surface and a first outer surface and wherein the second layer includes a second inner surface and a second outer surface, and wherein at least a portion of the first inner surface of the first layer contacts the pivot shaft and at least a portion of the first outer surface of the first layer contacts the second inner surface of the second layer, and at least a portion of the second outer surface of the second layer contacts the bushing.

Variation 5 may include a pivot shaft assembly as set forth in any of Variations 3-4 further comprising a bearing housing having a bore defined by an inner surface of the bearing housing, and wherein the pivot shaft assembly is disposed within the bore, and wherein the bearing housing includes a water jacket which surrounds the bushing.

Variation 6 may include a pivot shaft assembly as set forth in Variation 5 wherein the bearing housing further includes a dam adjacent the bore, and wherein the dam is constructed and arranged to direct a flow of fluid through the bushing.

Variation 7 may include a pivot shaft assembly as set forth in any of Variations 1-6 wherein the first layer is an o-ring and the second layer is an end cap.

Variation 8 may include a pivot shaft assembly as set forth in any of Variations 1-7 further comprising at least one piston ring surrounding the pivot shaft adjacent the polymeric seal.

Variation 9 may include a variable turbine geometry (VTG) turbocharger comprising: a turbine housing defining a turbine housing interior; a turbine wheel disposed within the turbine housing interior; a turbocharger shaft coupled to and rotatable by the turbine wheel, with the turbocharger shaft extending along a longitudinal axis that extends longitudinally through the turbine housing interior; a compressor housing defining a compressor housing interior; a compressor wheel disposed within the compressor housing interior and coupled to the turbocharger shaft, with the compressor wheel being rotatable by the turbocharger shaft; a bearing housing extending along the longitudinal axis between the turbine housing and the compressor housing, with the bearing housing defining a first bore extending along the longitudinal axis for receiving the turbocharger shaft and a second bore spaced from the first bore and extending along the longitudinal axis; and a variable turbine geometry assembly comprising, a vane ring disposed within the turbine housing interior and extending along the longitudinal axis, a plurality of vanes coupled to and movable with respect to the vane ring, an adjustment ring disposed between the vane ring and the bearing housing and extending along the longitudinal axis, with the adjustment ring coupled to the plurality of vanes for moving the plurality of vanes relative to the vane ring, a pivot shaft coupled to the adjustment ring and extending along the longitudinal axis, with the pivot shaft disposed within the second bore of the bearing housing, and with the pivot shaft configured to be actuated by the actuator for moving the adjustment ring with respect to the vane ring to move the plurality of vanes with respect to the vane ring, and a polymeric seal disposed within the second bore of the bearing housing for minimizing exhaust gas leakage from the turbine housing to an environment surrounding the bearing housing, with the polymeric seal comprising, a first layer disposed about the pivot shaft comprising a perfluoroelastomer, and a second layer adjacent the first layer and disposed about the pivot shaft, with the second layer comprising a polytetrafluoroethylene.

Variation 10 may include a VTG turbocharger as set forth in Variation 9 further comprising a bushing surrounding at least a portion of the pivot shaft positioned between the polymeric seal and an inner surface of the second bore.

Variation 11 may include a VTG turbocharger as set forth in any of Variations 9-10 wherein the pivot shaft further comprises a radial groove, and wherein at least a portion of the polymeric seal extends within the radial groove.

Variation 12 may include a VTG turbocharger as set forth in any of Variations 9-11 wherein the bearing housing is water cooled.

Variation 13 may include a VTG turbocharger as set forth in any of Variations 9-11 wherein the bearing housing further includes a water jacket.

Variation 14 may include a VTG turbocharger as set forth in any of Variations 10-13 wherein the bearing housing further includes a dam constructed and arranged to direct a flow of water through the bushing.

Variation 15 may include a VTG turbocharger as set forth in any of Variations 9-14 further comprising at least one piston ring surrounding a portion of the pivot shaft adjacent the polymeric seal.

Variation 16 may include a method of sealing a pivot shaft within a bore of a bearing housing of a turbocharger comprising: providing a polymeric seal within the bore of the bearing housing and around the pivot shaft to minimize exhaust gas leakage from the turbine housing to an environment surrounding the bearing housing, wherein the polymeric seal comprises a first layer comprising a perfluoroelastomer and a second layer comprising a polytetrafluoroethylene.

Variation 17 may include a method as set forth in Variation 16 further comprising providing a bushing around the polymeric seal.

Variation 18 may include a method as set forth in any of Variations 16-17 further comprising cooling the bearing housing to maintain the polymeric seal within an operating temperature range of the polymeric seal.

Variation 19 may include a method as set forth in any of Variations 17-18 further comprising providing a dam in the bearing housing to direct a flow of water through the bushing to prevent the flow of water from becoming stagnate.

Variation 20 may include a method as set forth in any of Variations 16-19 further comprising providing at least one piston ring adjacent the polymeric seal.

The above description of select variations within the scope of the invention is merely illustrative in nature and, thus, variations or variants thereof are not to be regarded as a departure from the spirit and scope of the invention.

1. A pivot shaft assembly for a variable turbine geometry (VTG) turbocharger comprising: a pivot shaft and a polymeric seal surrounding a portion of the pivot shaft, wherein the polymeric seal comprises a first layer and a second layer surrounding at least a portion of the first layer, and wherein the first layer comprises a perfluoroelastomer and the second layer comprises a polytetrafluoroethylene.

2. The pivot shaft assembly of claim 1 wherein the pivot shaft comprises a radial groove, and wherein at least a portion of the polymeric seal is disposed within the radial groove.

3. The pivot shaft assembly of claim 1 further comprising a bushing, and wherein the bushing surrounds the polymeric seal.

4. The pivot shaft assembly of claim 3 wherein the first layer includes a first inner surface and a first outer surface and wherein the second layer includes a second inner surface and a second outer surface, and wherein at least a portion of the first inner surface of the first layer contacts the pivot shaft and at least a portion of the first outer surface of the first layer contacts the second inner surface of the second layer, and at least a portion of the second outer surface of the second layer contacts the bushing.

5. The pivot shaft assembly of claim 4 further comprising a bearing housing having a bore defined by an inner surface of the bearing housing, and wherein the pivot shaft assembly is disposed within the bore, and wherein the bearing housing includes a water jacket which surrounds the bushing.

6. The pivot shaft assembly of claim 5 wherein the bearing housing further includes a dam adjacent the bore, and wherein the dam is constructed and arranged to direct a flow of fluid through the bushing.

7. The pivot shaft assembly of claim 1 wherein the first layer is an o-ring and the second layer is an end cap.

8. The pivot shaft assembly of claim 1 further comprising at least one piston ring surrounding the pivot shaft adjacent the polymeric seal.

9. A variable turbine geometry (VTC) turbocharger comprising:
a turbine housing defining a turbine housing interior;
a turbine wheel disposed within the turbine housing interior;
a turbocharger shaft coupled to and rotatable by the turbine wheel, with the turbocharger shaft extending along a longitudinal axis that extends longitudinally through the turbine housing interior;
a compressor housing defining a compressor housing interior;
a compressor wheel disposed within the compressor housing interior and coupled to the turbocharger shaft, with the compressor wheel being rotatable by the turbocharger shaft;
a bearing housing extending along the longitudinal axis between the turbine housing and the compressor housing, with the bearing housing defining a first bore extending along the longitudinal axis for receiving the turbocharger shaft and a second bore spaced from the first bore and extending along the longitudinal axis; and
a variable turbine geometry assembly comprising,
a vane ring disposed within the turbine housing interior and extending along the longitudinal axis,
a plurality of vanes coupled to and movable with respect to the vane ring,
an adjustment ring disposed between the vane ring and the bearing housing and extending along the longitudinal axis, with the adjustment ring coupled to the plurality of vanes for moving the plurality of vanes relative to the vane ring,
a pivot shaft coupled to the adjustment ring and extending along the longitudinal axis, with the pivot shaft disposed within the second bore of the bearing housing, and with the pivot shaft configured to be actuated by the actuator for moving the adjustment ring with respect to the vane ring to move the plurality of vanes with respect to the vane ring, and
a polymeric seal disposed within the second bore of the bearing housing for minimizing exhaust gas leakage from the turbine housing to an environment surrounding the bearing housing, with the polymeric seal comprising,
a first layer disposed about the pivot shaft comprising a perfluoroelastomer, and
a second layer adjacent the first layer and disposed about the pivot shaft, with the second layer comprising a polytetrafluoroethylene.

10. The VTG turbocharger of claim 9 further comprising a bushing surrounding at least a portion of the pivot shaft positioned between the polymeric seal and an inner surface of the second bore.

11. The VTG turbocharger of claim 9 wherein the pivot shaft further comprises a radial groove, and wherein at least a portion of the polymeric seal extends within the radial groove.

12. The VTG turbocharger of claim 9 wherein the bearing housing is water cooled.

13. The VTG turbocharger of claim 9 wherein the bearing housing further includes a water jacket.

14. The VTG turbocharger of claim 10 wherein the bearing housing further includes a dam constructed and arranged to direct a flow of water through the bushing.

15. The VTG turbocharger of claim 9 further comprising at least one piston ring surrounding a portion of the pivot shaft adjacent the polymeric seal.

16. A method of sealing a pivot shaft within a bore of a bearing housing of a turbocharger comprising: providing a polymeric seal within the bore of the bearing housing and around the pivot shaft to minimize exhaust gas leakage from the turbine housing to an environment surrounding the bearing housing, wherein the polymeric seal comprises a first layer comprising a perfluoroelastomer and a second layer comprising a polytetrafluoroethylene.

17. The method of claim 16 further comprising providing a bushing around the polymeric seal.

18. The method of claim 16 further comprising cooling the bearing housing to maintain the polymeric seal within an operating temperature range of the polymeric seal.

19. The method of claim 17 further comprising providing a dam in the bearing housing to direct a flow of water through the bashing to prevent the flow of water from becoming stagnate.

20. The method of claim 16 further comprising providing at least one piston ring adjacent the polymeric seal.
